(19) United States
(12) Patent Application Publication
(10) Pub. No.: US 2005/0131627 A1
(43) Pub. Date: Jun. 16, 2005

(54) Traffic management in a roadway travel data exchange network

(76) Inventor: Gary Ignatin, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/014,121

(22) Filed: Dec. 15, 2004

Related U.S. Application Data
(60) Provisional application No. 60/530,087, filed on Dec. 15, 2003.

(51) Int. Cl. G06F 19/00

(52) U.S. Cl. 701/117

(57) ABSTRACT

Systems and methods for traffic management in a roadway travel data exchange network are disclosed. In one embodiment, a traffic management system may comprise, for example, a first mobile traffic participant communicatively coupled to a communication network, a second mobile traffic participant communicatively coupled to the communication network, and at least one traffic control system communicatively coupled to the communication network. The traffic control system may receive travel data associated with the first mobile traffic participant, and may generate a first traffic control instruction based on the received travel data. The first traffic control instruction may be associated with the second mobile traffic participant. The first traffic control instruction may comprise routing information for the second mobile traffic participant.

### RELATED APPLICATIONS

This application makes reference to, claims priority to, and claims the benefit of U.S. Provisional Patent Application Ser. No. 60/530,087, entitled “Traffic Management In A Vehicular Travel Data Exchange Network” (Attorney Docket No. 15237US01), filed Dec. 15, 2003, the complete subject matter of which is hereby incorporated herein by reference, in its entirety.

### INCORPORATION BY REFERENCE

In addition, the applicant hereby incorporates the complete subject matter herein by reference, in its entirety, of U.S. patent application Ser. No. 10/736,819, entitled “Roadway Travel Data Exchange Network” (Attorney Docket No. 15235US01), filed Dec. 15, 2003.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Vehicles currently may use navigation systems to display their present location on a map and to provide driving directions to other locations. Internet mapping web sites may also be utilized in order to obtain a map of a specific location, or driving directions from one location to another. Global Positioning System (GPS) technology may be used to determine vehicle location. In addition, a database of roadway information stored, for example, on a CD-ROM may provide route calculations based on that location and may display driving directions based on a fastest, or a shortest, route between two locations.

Often times, however, the selected route is not the fastest due to temporary, or unforeseen, roadway conditions. Examples of such conditions may be roadway construction or a traffic accident. When such roadway conditions exist, for example, a traffic accident on a busy intersection, there may be no immediate traffic control in the surrounding vicinity, in response to the traffic accident. Traffic may continue to back up and block an increasing number of intersections surrounding the accident site.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be found in, for example, systems and methods for traffic management in a roadway travel data exchange network. In one embodiment, a traffic management system may comprise, for example, a first mobile traffic participant communicatively coupled to a communication network, a second mobile traffic participant communicatively coupled to the communication network, and at least one traffic control system communicatively coupled to the communication network. The traffic control system may receive travel data associated with the first mobile traffic participant, and may generate a first traffic control instruction based on the received travel data. The first traffic control instruction may be associated with the second mobile traffic participant.

The first traffic control instruction may comprise routing information for the second mobile traffic participant. The travel data associated with the first mobile traffic participant may comprise a location and/or a velocity of the first mobile traffic participant. A traffic signal may be communicatively coupled to the communication network. The traffic control system may generate a second traffic control instruction for control of the traffic signal. The traffic management system may also comprise a monitoring device for processing travel data, where the monitoring device may be associated with the second mobile traffic participant. The monitoring device may be adapted to collect, transmit, receive, and/or display travel data. The monitoring device may be embedded in the second mobile traffic participant.

In another exemplary aspect of the invention, a traffic management system may comprise a mobile traffic participant communicatively coupled to a communication network and a traffic control system communicatively coupled to the communication network. The traffic control system may be adapted to receive travel data and at least one user-defined preference associated with the mobile traffic participant. The traffic control system may then generate a traffic control instruction based on the received travel data and/or the user-defined preference. The traffic control instruction may be associated with the mobile traffic participant. The traffic control system may provide routing information to the mobile traffic participant based on the received travel data and/or a user-defined preference. The user-defined preference may comprise a food, a beverage, a lodging, and/or an advertisement opt-in preferences.

In yet another exemplary aspect of the invention, a method for traffic management in a roadway travel data exchange network may comprise receiving, via a communication network, travel data associated with a first mobile traffic participant. A traffic control instruction may be generated based on the received travel data. The traffic control instruction may be transmitted over the communication network to a second mobile traffic participant. The traffic control instruction may relate to providing routing information to the second mobile traffic participant. A traffic control instruction may be transmitted over the communication network to a traffic signal. Routing information may be provided to the mobile traffic participant upon receipt of travel data by a traffic control system in the roadway travel data exchange network.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1A is a diagram of a traffic accident site illustrating an embodiment of traffic management in a roadway travel data exchange network, in accordance with various aspects of the present invention.

FIG. 1B is a diagram of a highway off-ramp illustrating an embodiment of traffic management in a roadway travel data exchange network, in accordance with various aspects of the present invention.

FIG. 2 is a flowchart illustrating an embodiment of a method for traffic management in a roadway travel data exchange network, in accordance with various aspects of the present invention.

FIG. 3 is a diagram illustrating an embodiment of a roadway travel data exchange network supporting collection, processing and delivery of travel data, in accordance with various aspects of the present invention.

FIG. 4 is a diagram illustrating a plurality of client systems on the roadway travel data exchange network of FIG. 3, for example, in accordance with various aspects of the present invention.

FIG. 5 is a diagram illustrating a more specific embodiment of a client system on the roadway travel data exchange network of FIG. 3, for example, in accordance with various aspects of the present invention.

FIG. 6 is a diagram illustrating an embodiment of a vehicle interface on the plurality of client systems of FIG. 4, for example, in accordance with various aspects of the present invention.

FIG. 7 is a diagram illustrating an embodiment of post-processing information delivery systems on the roadway travel data exchange network of FIG. 3, for example, in accordance with various aspects of the present invention.

FIG. 8 is a diagram illustrating an embodiment of a storage and processing system on the roadway travel data exchange network of FIG. 3, for example, in accordance with various aspects of the present invention.

FIG. 9 is a flowchart illustrating a general embodiment of a method for collection and delivery of travel data on the roadway travel data exchange network of FIG. 3, for example, in accordance with various aspects of the present invention.

### DETAILED DESCRIPTION OF THE INVENTION

Certain embodiments of the present invention relate to traffic management in a roadway travel data exchange network. In particular, certain embodiments of the present invention enable collection, processing, and delivery of real-time travel data and certain traffic control information. The real-time travel data may be collected and distributed automatically by a plurality of vehicles that are traveling at a given time. The traffic control information may be communicated to a specific vehicle, or a plurality of vehicles, and may depend on the real-time travel data and user-defined preferences.

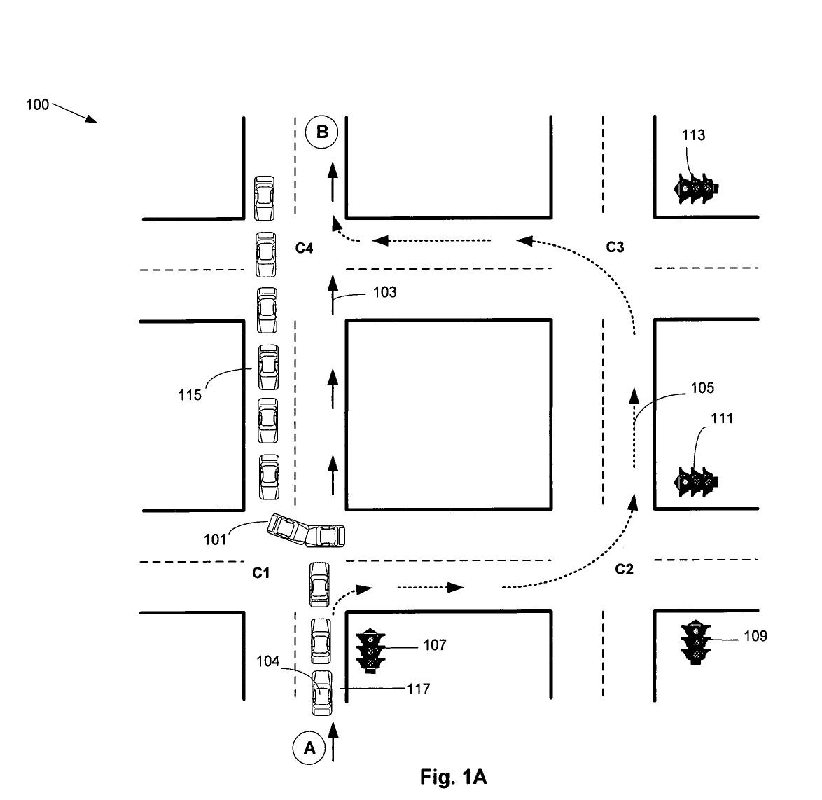

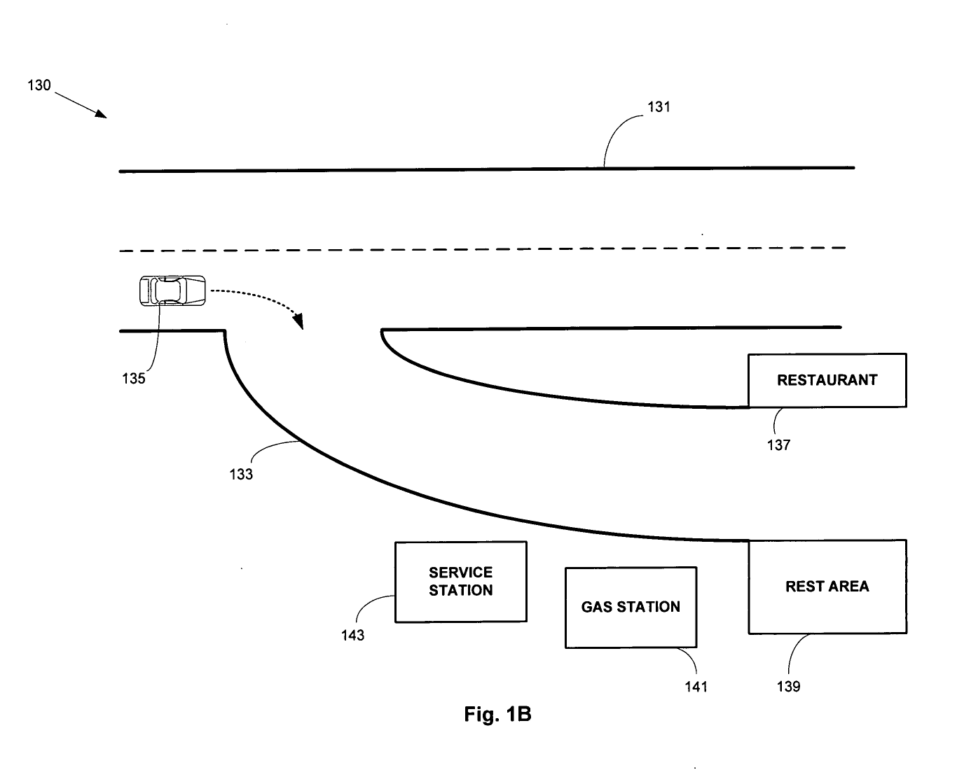

FIG. 1A is a diagram of a traffic accident site illustrating an embodiment of traffic management in a roadway travel data exchange network, in accordance with various aspects of the present invention. The traffic accident site 100 may affect, for example, several intersections—C1, C2, C3 and C4. The traffic accident 101 on intersection C1 may involve two vehicles. As a result of the accident, traffic in the two opposite lanes 115 and 117 may be backed-up. Real-time travel data associated with the accident 101 may be communicated via a travel data exchange network, in accordance with various embodiments of the present invention.

In an embodiment of the present invention, a vehicle 104 on lane 117, for example, may have requested routing information from a traffic control system on the roadway travel data exchange network with regard to traveling from location A to location B. The traffic control system may be software, hardware, firmware, or any combination thereof. In addition, a traffic control system may be located within a vehicle or outside a vehicle. The traffic control system may have returned an instruction for the vehicle to follow route 103 as the fastest route. Since the accident 101, however, is located on the recommended route 103, the traffic control system will take into account updated real-time travel data relating to the accident 101 and will provide vehicle 104 with an updated routing information. For example, the traffic control system may receive updated real-time travel data and may provide vehicle 104 with an updated fastest route, which may be, for example, route 105.

The updated route 105 may be communicated to other vehicles in the vicinity of accident 104 as an alternative “detour” route in order to avoid traffic congestion. The updated route 105 may also be communicated to the entire roadway travel data exchange network as a “traffic alert” information so that approaching vehicles may request detour information in advance.

In another embodiment of the present invention, the traffic control system may control traffic signals as a way of providing traffic control in the roadway travel data exchange network. For example, the traffic control system may engage traffic lights 107, 109, 111 and 113 upon occurrence of the accident 101, or soon thereafter. The red traffic signal on traffic lights 107, 109, 111, and 113 may be turned on as a way of limiting the inflow of new traffic into the accident area. In this way, traffic near the accident site will be controlled and traffic congestion alleviated.

New routing information, updated routing information or any other traffic control instruction, may be provided by the traffic control system automatically upon receipt by the traffic control system of real-time travel data.

FIG. 1B is a diagram of a highway off-ramp illustrating an embodiment 130 of traffic management in a roadway travel data exchange network, in accordance with various aspects of the present invention. Specifically, in one embodiment of the present invention, a vehicle 135 may be traveling on highway 131 and a traffic control system may instruct vehicle 135 to exit the highway via the off-ramp 133 based on a user-defined set of preferences communicated to the traffic control system. Vehicle 135 may be provided with such set of user-defined preferences that may relate to at least one of a gas station preference, a restaurant preference, a rest area preference, a service station preference, and an advertisement opt-in preference. A gas station preference may, for example, cause the traffic control system to instruct the vehicle to take a specific route in order to locate the nearest preferred gas station. In this case, vehicle 135 will receive an instruction from the traffic control system that the vehicle will need to take off-ramp 133 in order to get to the preferred gas station 141.

Similarly, a user-defined preference may cause the traffic control system to instruct vehicle 135 to exit on off-ramp 133 because of a convenient location of a preferred service station 143, a preferred rest area 139, or a preferred restaurant 137.

In an embodiment of the present invention, the traffic control system may instruct vehicle 135 to exit the highway via the off-ramp 133 based on real-time travel data associated with vehicle 135. For example, the traffic control system may receive real-time travel data originating from a seat sensor in vehicle 135. The seat sensor may provide real-time travel data associated with, for example, the driver fatigue status, and it may further indicate that the driver may be falling asleep on the wheel. The traffic control system may then instruct vehicle 135 to exit the highway via the off-ramp 133 and visit rest area 139 to take a rest or for coffee refreshment.

Real-time travel data associated with vehicle 135 may relate to different characteristics of the traffic, a mobile vehicle and/or a vehicle occupant, and the traffic control system may provide different traffic control instructions based on the specific real-time travel data.

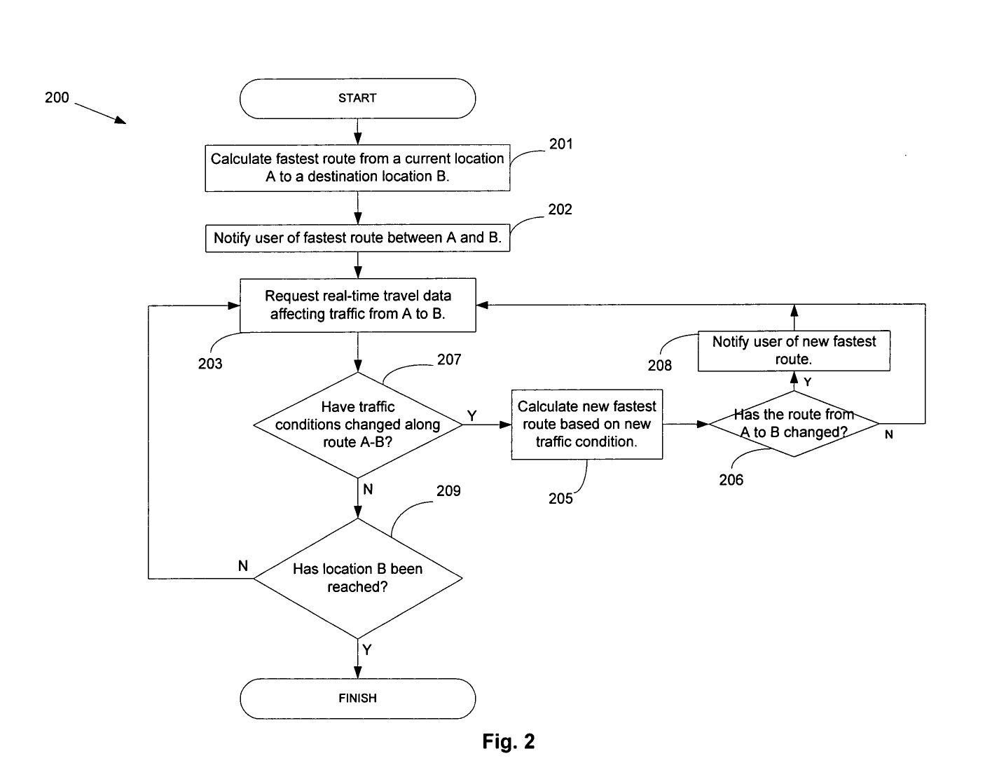

FIG. 2 is a flowchart illustrating an embodiment of a method 200 for traffic management in a roadway travel data exchange network, in accordance with various aspects of the present invention. A traffic control system in the roadway travel data exchange network may receive a request from a vehicle for calculating, for example, the fastest route from a current location A to a destination location B. After calculating such route, at 201, the calculated route between A and B may be communicated to the user, at 202. At 203, the traffic control system may continuously request real-time travel data affecting traffic along the potential routes between A and B. At 207, it may be determined whether there is a change in the traffic conditions along the potential routes from A to B, such as, for example, an accident or road construction on the current route from A to B, or the removal of an accident resulting in improved traffic flow on an alternate route from A to B.

If there is a change in the traffic conditions along the route from A to B, at 205, the traffic control system may calculate new fastest route based on one or more new traffic conditions. At 206, it may be determined whether the calculated route from A to B has changed. If the route from A to B has changed, at 208, the user may be notified of the new fastest route and real time travel data affecting traffic from A to B may be requested at 203. If the new route from A to B has not changed, then real time travel data affecting traffic from A to B may be requested at 203. If there is no change in the traffic conditions along the route from A to B, at 209, it may be determined whether location B has been reached. If location B has not been reached, real time travel data affecting traffic from A to B may again be requested at 203.

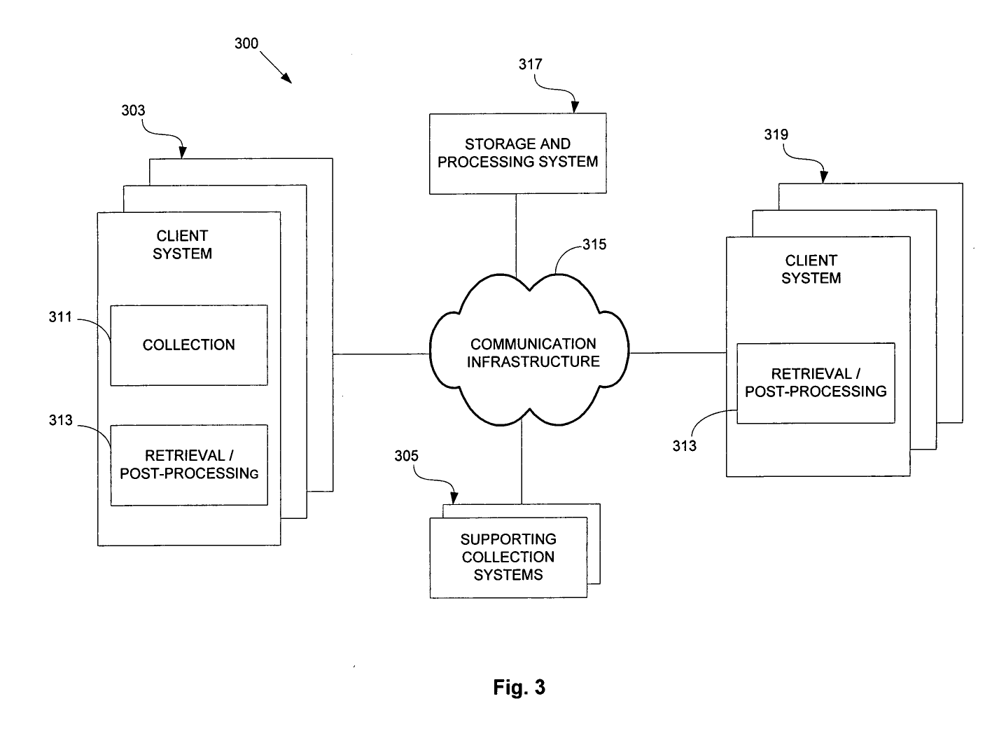

FIG. 3 is a diagram illustrating a roadway travel data exchange network 300 supporting collection, processing and exchange of travel data, in accordance with various aspects of the present invention. The roadway travel data exchange network 300 comprises a communication infrastructure 315, pluralities of client systems 303 and 319, supporting collection systems 305, and a storage and processing system 317. The plurality of client systems 303 comprise collection systems 311 and retrieval/post-processing systems 313. However, the plurality of client systems 319 comprise retrieval/post-processing systems 313 and no collection systems 311.

The plurality of client systems 303 collect travel data and deliver the collected data to the storage and processing system 317 via the communication infrastructure 315. The storage and processing system 317 also receives collected travel data from the supporting collection systems 305. These collection processes occur both periodically and in real time.

To support the pluralities of client systems 303 and 319, the storage and processing system 317 correlates, combines and otherwise processes the collected travel data to generate processed data and instructions. The processed data and instructions are delivered to the pluralities of client systems 303 and 319 via the communication infrastructure 315 for post-processing. Post-processing by the pluralities of client systems 303 and 319 may include, for example, communicating the processed data to the user, further computation, control and storage.

Some of the pluralities of client systems 303 and 319 are installed in roadway vehicles. Others of the pluralities of client systems 303 and 319 are portable devices that may be carried inside roadway vehicles. Yet other of the pluralities of client systems 303 and 319 are neither installed nor carried inside roadway vehicles. The plurality of client systems 303, installed or associated with roadway vehicles: (1) collect travel data via the collection systems 311; (2) exchange collected travel data with the storage and processing system 317, the client systems 319, others of the client systems 303, and the supporting collection systems 305; and (3) post-process travel data retrieved from the storage and processing system 317, the client systems 319, others of the client systems 303, and the supporting collection systems 305. Although the plurality of client systems 319 do not perform collection, they also post-process such retrieved and received travel data via the communication infrastructure from the systems 317, 303, 305, and other client systems 319.

The pluralities of client systems 303 and 319 may be categorized as multi-purpose or dedicated client systems. The characteristic feature of a multi-purpose client system is that it may perform various functions related to the travel data as well as additional functions that are not related to travel data. A dedicated client system can only perform functions related to the travel data.

Collection of travel data by the plurality of client systems 303 is accomplished in several ways. Some of the plurality of client systems 303 receive instructions from the systems 317, 319 and 305 and from others of the client systems 303 to deliver, or collect and deliver, certain travel data. Any of the plurality of client systems 303 may be pre-configured or instructed to regularly collect and deliver such travel data without awaiting specific requests. Such “pre-arranged” collection and delivery can occur continuously or as travel data becomes available. The collection and delivery process performed by each of the plurality of client systems 303 may be activated or deactivated via the communication infrastructure or through direct interaction with the client systems 303. The retrieval and post-processing of the plurality of client systems 303 may be similarly activated or deactivated.

Another way for collecting information is for the plurality of client systems 303 to automatically initiate collection (and subsequent delivery) of travel data. For example, upon sensing motion, periodic collection and delivery might be automatically initiated by the client systems 303. Such client system 303 might also periodically collect and deliver the moving vehicle's geographic location, its speed, direction and other travel data. Alternatively, the plurality of client systems 303 may be triggered manually to initiate collection and/or delivery of travel data.

After processing travel data delivered by one of the plurality of client systems 303, the storage and processing system 317 may return processed travel data and/or instructions to the delivering one of the plurality of client systems 303. In addition, the storage and processing system 317 delivers the processed travel data and related instructions to others of the pluralities of client systems 303 and 319. For example, processed travel data may be delivered to one of the client systems 303 in response to travel data collected from another of the client systems. Any of the pluralities of client systems 303 and 319 that receive the processed travel data or related instructions may forward same or post-process and forward post-processed data or instructions to yet others of the pluralities of client systems 303 and 319.

The roadway travel data exchange network 300 is enhanced with capability of receiving additional information that may relate to travel. Such additional travel-related information may be collected by supporting collection systems 305. For example, various governmental agencies or news organizations will have the capability to contribute travel-related data. Governmental agencies that may contribute travel-related data to the roadway travel data exchange network include, for example, a local city police department, a state police department, a sheriffs department, a highway patrol, and a meteorological agency. The travel-related data may be collected by using a client system 303, in a similar manner as discussed above. The travel-related data may comprise, for example, information about the number of vehicles that pass through a certain part of a road, vehicle speed, and direction of travel. If the travel-related data is collected by the governmental agency representative using a device similar to a client system 303, the device may automatically collect and transmit the travel-related data to the storage and processing system 317 for further processing. The governmental agency representative may also collect travel-related data by observation and then enter it into the roadway travel data exchange network by transmitting it directly to the storage and processing system 317. For example, a police officer may be monitoring a busy road intersection and may observe a traffic accident. As a result of the accident, all lanes of the road may become blocked and traffic flow may quickly deteriorate. The police officer may then transmit to the storage and processing system 317 his exact location and the fact that the specific road has been blocked in both directions due to a traffic accident.

The supporting collection systems 305 may comprise, for example, weather-related data collection systems. The weather-related data may be automatically collected by weather sensors placed at key intersections, highways, or roads. The weather-related data may include, for example, outside temperature, precipitation amount and emergency weather data (such as information for an approaching tornado). Certain weather-related data may be entered into the roadway travel data exchange network and transmitted to the storage and processing system 317 via a client system 303. The supporting collection systems 305 may also comprise a meteorological data collection system that delivers travel data in the form of weather information to the storage and processing system 317.

The supporting collection systems 305 also deliver travel data directly to the client systems 303 and 319 for post-processing via the communication infrastructure 315. Instructions may also be delivered by the supporting collection systems 105 to the storage and processing system 317 or the client systems 303 and 319 via the communication infrastructure 315.

The pluralities of client systems 303 and 319 have display capabilities so that collected and processed travel data may be displayed for a user as part of the post-processing functionality of the retrieval/post-processing systems 313. For example, some of the plurality of client systems 303 transmit geographic location (corresponding to either the location of the client system or any other selected location) to the storage and processing system 317, requesting related weather and speed information. In response to such request, the storage and processing system 317 uses the geographic location to access stored travel data to produce the related weather and speed information for delivery to the requesting client system.

The communication infrastructure 315 may comprise a single communication network or a plurality of communication networks. Such networks may comprise wired and wireless portions. More specifically, collection of information and transmission of the collected information via the communication infrastructure 315 may be accomplished by using wireless transmission methods, such as General Packet Radio Service (GPRS) or Wideband Code Division Multiple Access (WCDMA). Collection and transmission on the communication infrastructure 315 may also be accomplished using radio, 802.11 network, ultrawideband communication, or any other means that allow sufficient freedom of movement. Delivery of information on the communication infrastructure 315 can be accomplished by using the same wireless transmission methods that are used for transmission of the collected information. In addition, delivery via the communication infrastructure 315 may be accomplished by using a cable infrastructure, a satellite network infrastructure, a digital subscriber line (DSL) infrastructure, an Internet infrastructure, an intranet infrastructure, a wired infrastructure, a closed communication infrastructure, and a local area network. Complimentary technology exists on the roadway travel data exchange network 300, including the storage and processing system 317, and the client systems 303 and 319 in order to use the communication infrastructure and process travel data on the roadway travel data exchange network.

In an embodiment of the present invention, the roadway travel data exchange network may comprise a plurality of storage and processing systems. For example, in order to increase efficiency in the exchange of information, a storage and processing system may be placed near several major roads or intersections so that travel data may be reported to the storage and processing system which is closest to the reporting vehicle. The plurality of storage and processing systems may be connected together, or to a main storage and processing system, via the communication infrastructure 315. The plurality of processing systems may each be deployed to provide different services or portions of an overall service offering. In such cases, the client systems may employ post-processing that correlates or otherwise combines the services or service information delivered by the plurality of processing systems.

In another embodiment of the present invention, a plurality of client systems 303 may be utilized, as well as a plurality of client systems 319. Travel data that is collected by one or more of the collection systems 311 on the client systems 303 may be transmitted to, and processed by, a storage and processing system. Subsequent results may be utilized by the same client systems 303 which collected the travel data, or by other client systems 303. The same results, however, may also be utilized by one or more of the retrieval/post-processing systems 313 on the plurality of client systems 319.

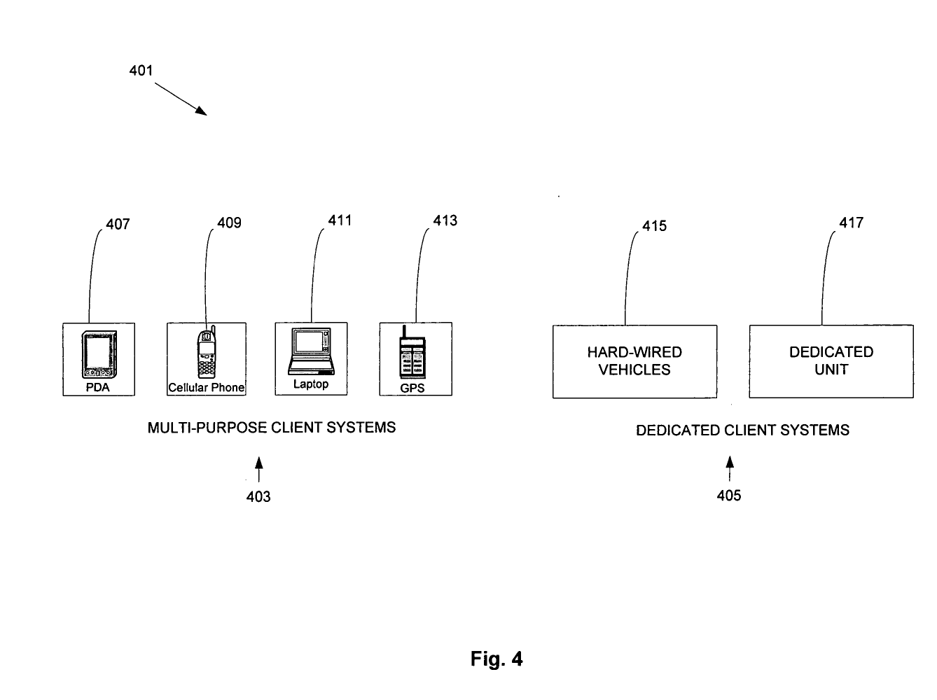

FIG. 4 is a diagram illustrating a plurality of client systems on the roadway travel data exchange network of FIG. 3, for example, in accordance with various aspects of the present invention. The plurality of client systems 401 may comprise one or more of the multipurpose client systems 403 and/or one or more of the dedicated client systems 405. More specifically, the multipurpose client system 403 may be, for example, one or more of a personal digital assistant (PDA) 407, a cellular phone 409, a laptop computer 411, and a global positioning system (GPS) device 413. The multipurpose client system 403 is enabled to collect, transmit, receive and deliver travel data. However, the multipurpose client system 403 may perform additional functions as well. For example, the PDA 407 may store and recall personal information. The dedicated client system 405 may only perform functions related to the travel data. The dedicated client system 405 may comprise a client system 415 physically embedded (“hardwired”) in the vehicle. A dedicated client system 405 may also be designed as a portable dedicated unit 417.

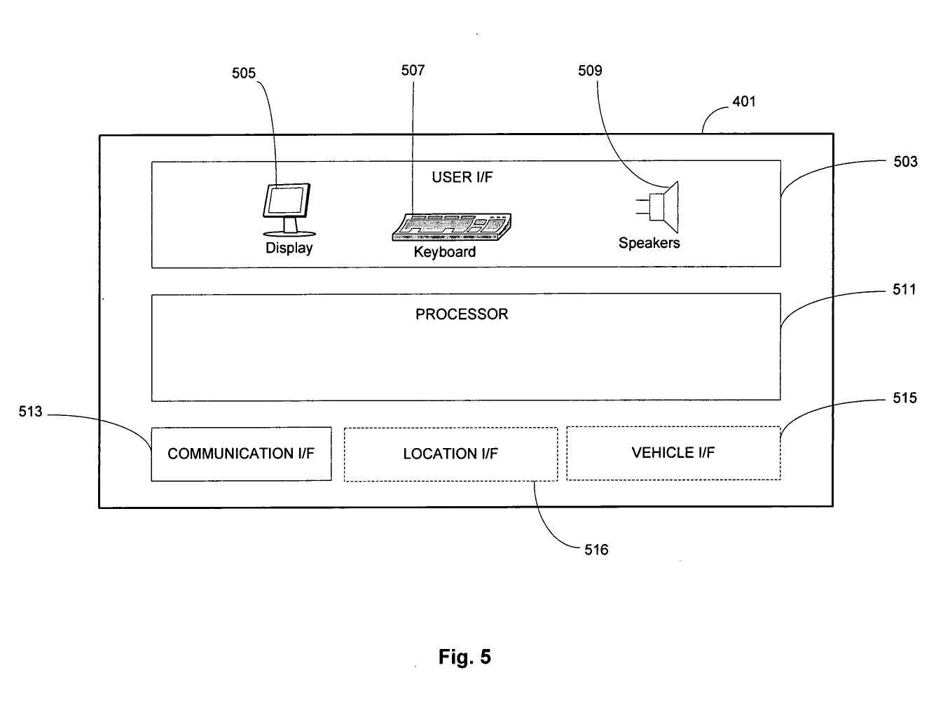

Referring now to FIG. 5, there is illustrated a more specific embodiment of one of the client systems 401 in the roadway travel data exchange network of FIG. 3, for example, in accordance with various aspects of the present invention. In order to accomplish efficient exchange of travel data, the client system 401 comprises a user interface 503, a processor 511 and a communication interface 513.

The client system 401 is adapted to collect, transmit, receive and deliver travel data. Where the client system 401 is “dedicated” or embedded in a vehicle, a vehicle interface 515 supports the collection of travel data related to the vehicle in which it is embedded. Such travel data may comprise, for example, information on the vehicle speed, tire pressure, airbag deployment, etc.

In the present embodiment, geographic location information of a vehicle is determined through location circuitry. If the location circuitry is present in the vehicle in which the client system is located, then the location circuitry will deliver the geographic location information to the client system 401 via the vehicle interface 515. However, if the vehicle lacks location circuitry, the client system 401 may comprise location circuitry within a location interface 516. For example, in one embodiment, the location interface 516 comprises GPS (Global Positioning System) circuitry. In other embodiments, geographic location may be determined by any sufficiently reliable mechanisms for determining location, such as mechanisms employing triangulation techniques. The GPS circuitry may also assist in determining speed and direction of a vehicle if such travel data may not be collected directly via the vehicle interface 515.

The user interface 503 comprises a keyboard 507, which may be used to enter travel data manually or otherwise interact with the client system 401. For example, the keyboard might be used to request travel data from the storage and processing system 317 of FIG. 3. Of course, any other user input devices such as a touchscreen, mouse, buttons, dials or switches might also, or alternatively, be used.

Travel data which is delivered to the client system 401 is displayed on a display 505. The client system 401 may also provide for audible notification of the received travel data via speakers 509. Information which is entered or received via the client system 401 is processed by the processor 511. A communication interface 513 communicatively couples the client system 401 with the communication infrastructure so as to provide access to the storage and processing system 317, for example. Through the communication interface 513, processed, post-processed and collected travel data is exchanged. For example, the storage and processing system 317 delivers processed travel data to the client system 401 for display and audible output on the display 505 and speakers 509 respectively.

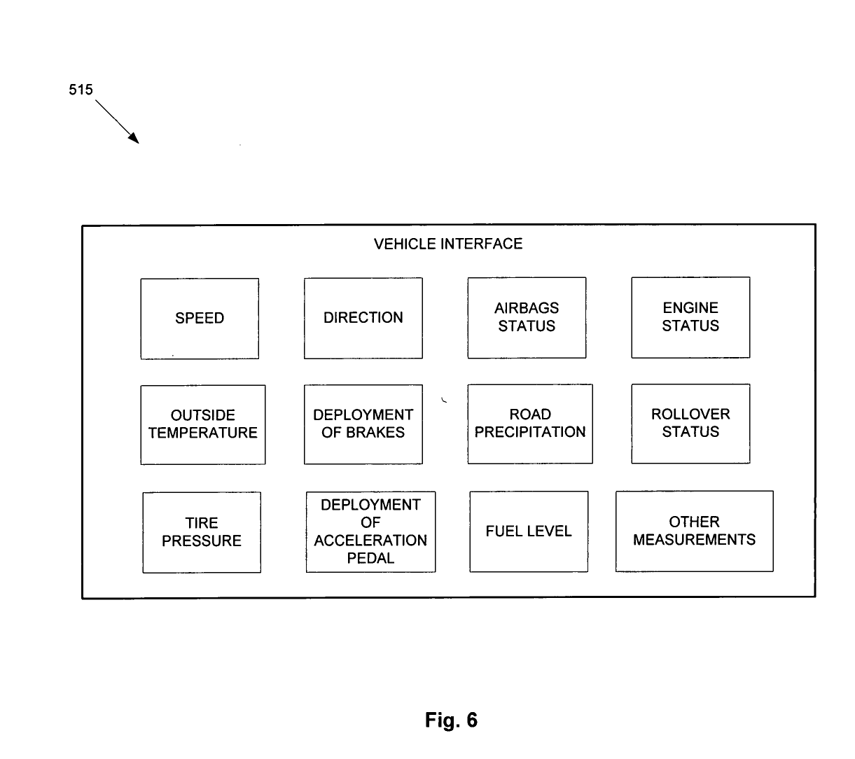

Referring now to FIG. 6, there is illustrated a diagram of an embodiment of a vehicle interface on the plurality of client systems of FIG. 4, for example, in accordance with various aspects of the present invention. The vehicle interface 515 provides functionality for collecting travel data that is related to the vehicle in which it is embedded. Travel data that may be collected by a client system may include, for example, a geographic location, a speed, a direction, an airbag status, an engine status, an outside temperature, a deployment status of vehicle brakes, a road precipitation status, a rollover status, a tire pressure status, a deployment status of an acceleration pedal, and a fuel level.

Geographic location information of a vehicle may be determined, for example, through a GPS, such as the GPS 413 of FIG. 4. GPS may also assist in determining speed and direction of a vehicle if the client system is not embedded and such travel data may not be collected directly via the vehicle interface 515. Speed and direction of a vehicle may be determined by measuring the vehicle's location with a GPS several times over a specific time interval. The traveled distance and time may then be calculated and may be used to determine speed and direction.

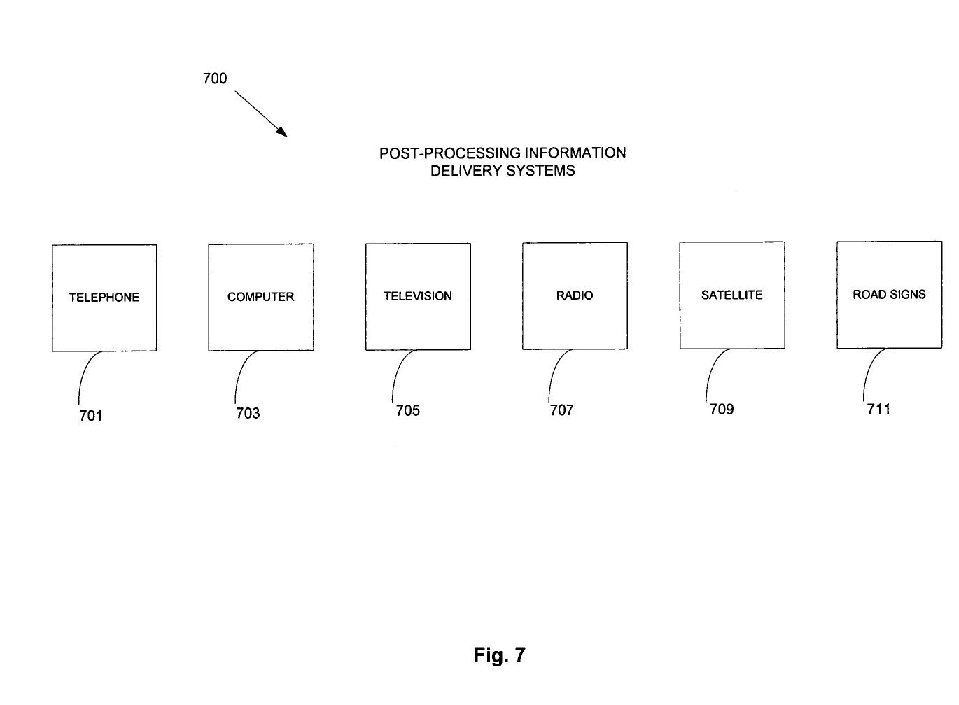

Referring now to FIG. 7, there is illustrated an embodiment of post-processing information delivery systems on the roadway travel data exchange network of FIG. 3, for example, in accordance with various aspects of the present invention. Various post-processing information delivery systems 700 may be utilized in the retrieval/post-processing systems 313 of FIG. 3. Travel data communicated from the storage and processing system 317 may, for example, be delivered to a telephone 701, a computer 703, a television 705, a radio 707, a satellite 709, or a road sign display 711.

The telephone 701 may, for example, be a dedicated telephone line. Users of the roadway travel data exchange network may dial this dedicated phone line and hear a recorded message with specific travel data. The contents of the recorded message may be periodically updated with new travel data. Several post-processing information delivery systems may be utilized at the same time. For example, information about an accident may be displayed on a road sign display 711, while at the same time a radio 707 may broadcast information on alternate routes that may be utilized around the accident site.

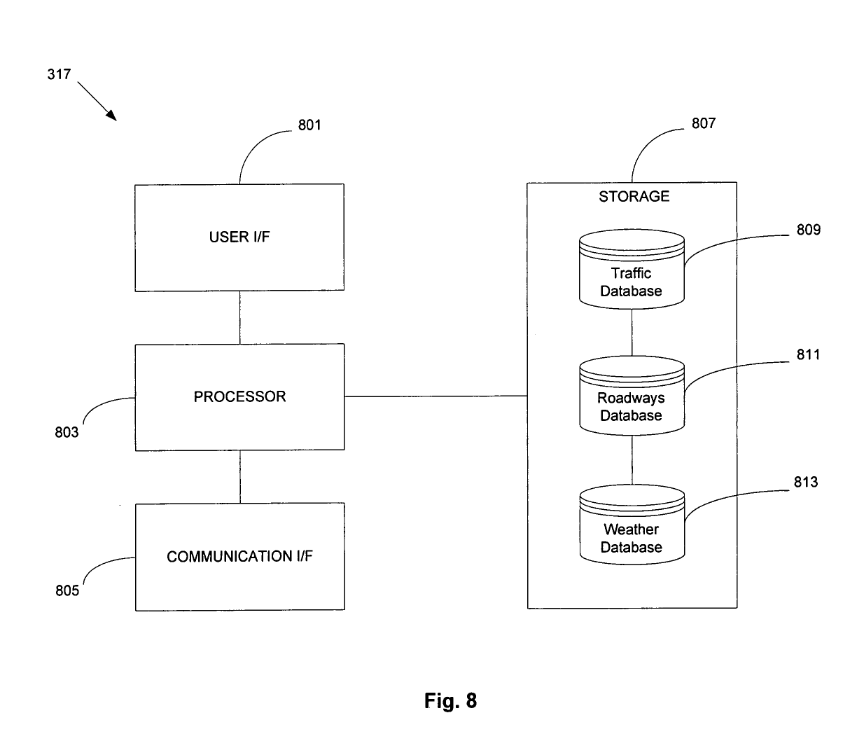

Referring now to FIG. 8, there is illustrated an embodiment of a storage and processing system on the roadway travel data exchange network of FIG. 3, for example, in accordance with various aspects of the present invention. The storage and processing system 317 comprises a communication interface 805 for communicating with the roadway travel data exchange network via the communication infrastructure 315 of FIG. 3. Travel data received by the storage and processing system 317 via the communication interface 805 is processed by a processor 803, and is subsequently stored in storage 807. The storage 807 comprises several databases, which are associated with the type of travel data they contain. For example, the storage 807 comprises a travel database 809, a roadways database 811, and a weather database 813. The travel database 809 stores all roadway travel data related to traffic. The roadways database 811 stores information about the specific geographic location of a roadway network and specific roadway characteristics, such as type of road, length, maximum allowed speed, number of lanes, etc. The weather database stores the weather-related data that is received, for example, from supporting collection systems 305 of FIG. 3. The storage and processing system 317 may also comprise a user interface 801, which may allow an authorized user to directly input into the storage and processing system traffic-related, roadway-related, or weather-related information, or to edit existing information.

In an embodiment of the present invention, the roadway travel data exchange network may comprise a plurality of storage and processing systems. For example, in order to increase efficiency in the exchange of information, a storage and processing system may be placed near several major roads or intersections so that travel data may be reported to the storage and processing system which is closest to the reporting vehicle. The plurality of storage and processing systems may be connected together, or to a main storage and processing system, via the communication network infrastructure 315.

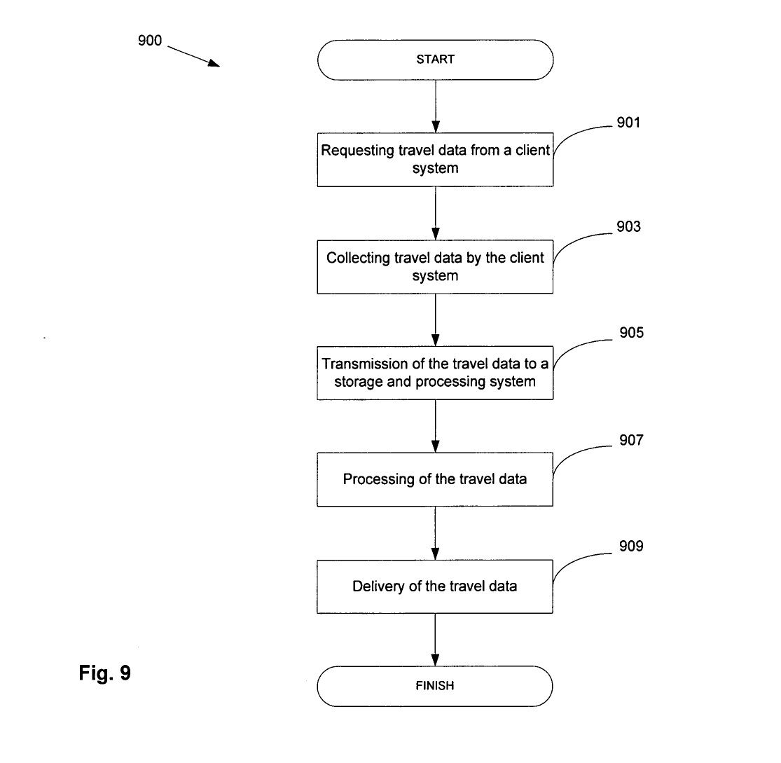

FIG. 9 is a flowchart illustrating a general embodiment of a method 900 for collection and delivery of real-time travel data on the roadway travel data exchange network of FIG. 3, for example, in accordance with various aspects of the present invention. At 901, travel data is requested by the storage and processing system 317 from a client system. At 903, a multipurpose client system or a dedicated client system collects the requested travel data. At 905, the client system transmits the collected travel data to the storage and processing system via a communication network infrastructure. After the travel data is processed by a processor at the storage and processing system at 907, it may be stored in a storage at the storage and processing system. At 909, the travel data is delivered from the storage and processing system to the same client system or to another client system for post-processing.

In an exemplary aspect of the invention, a roadway travel data exchange network may be adapted to utilize one or more user preferences during collection, processing, and delivery of real-time travel data and/or certain traffic control information. The one or more user preference may be determined and stored in advance for subsequent use by the roadway travel data exchange network after travel has been initiated. Further, the user preference may also be inputted, or stored, in the roadway travel data exchange network during travel. For example, a user of the roadway travel data exchange network may prefer traveling only on highways and this preference may be entered for consideration by the roadway travel data exchange network during any subsequent route calculations. In addition, the user may express preference of traveling only on highways, unless an alternate route may save a determined amount of time, such as a minimum of 20 minutes, for example, if the alternate route is taken.

In another exemplary aspect of the invention, roadway travel data exchange network may be utilized when a starting location is known but a final location destination is unknown. For example, a roadway travel data exchange network may be utilized during collection, processing, and delivery of real-time travel data when a first vehicle is following a second vehicle, for example. The first vehicle may be adapted to dynamically receive travel data associated with the second vehicle. Such travel data may include, for example, the second vehicle's current location, speed, roadway travel information with regard to the second vehicle, etc. The first vehicle may then utilize the travel data associated with the second vehicle to determine fastest route, for example, to the current location of the second vehicle.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A traffic management system, comprising:
a first mobile traffic participant communicatively coupled to a communication network;
a second mobile traffic participant communicatively coupled to the communication network; and
at least one traffic control system communicatively coupled to the communication network, wherein the at least one traffic control system receives travel data associated with the first mobile traffic participant, and generates a first traffic control instruction based on the received travel data, the first traffic control instruction associated with the second mobile traffic participant.

2. The traffic management system of claim 1, wherein the first traffic control instruction comprises routing information for the second mobile traffic participant.

3. The traffic management system of claim 1, wherein the travel data associated with the first mobile traffic participant comprises at least one of a location of the first mobile traffic participant and a velocity of the first mobile traffic participant.

4. The traffic management system of claim 1, further comprising at least one traffic signal communicatively coupled to the communication network.

5. The traffic management system of claim 4, wherein the at least one traffic control system generates a second traffic control instruction for control of the at least one traffic signal.

6. The traffic management system of claim 1, further comprising at least one monitoring device for processing travel data, the at least one monitoring device associated with the second mobile traffic participant.

7. The traffic management system of claim 6, wherein the at least one monitoring device collects travel data.

8. The traffic management system of claim 6, wherein the at least one monitoring device transmits travel data.

9. The traffic management system of claim 6, wherein the at least one monitoring device receives travel data.

10. The traffic management system of claim 6, wherein the at least one monitoring device displays travel data.

11. The traffic management system of claim 6, wherein the at least one monitoring device is embedded in the second mobile traffic participant.

12. A traffic management system, comprising:
at least one mobile traffic participant communicatively coupled to a communication network; and
at least one traffic control system communicatively coupled to the communication network,
wherein the at least one traffic control system receives travel data and at least one user-defined preference associated with the at least one mobile traffic participant, and generates at least one traffic control instruction based on at least one of the received travel data and the at least one user-defined preference, the at least one traffic control instruction associated with the at least one mobile traffic participant.

13. The traffic management system of claim 12, wherein the at least one traffic control system provides routing information to the at least one mobile traffic participant based on at least one of the received travel data and at least one user-defined preference.

14. The traffic management system of claim 13, wherein the at least one user-defined preference comprises a food or beverage preference.

15. The traffic management system of claim 13, wherein the user-defined preference comprises a lodging preference.

16. The traffic management system of claim 13, wherein the user-defined preference comprises an advertisement opt-in preference.

17. A method for traffic management in a roadway travel data exchange network, comprising:
receiving, via a communication network, travel data associated with a first mobile traffic participant;
generating at least one traffic control instruction based on the received travel data; and
transmitting the at least one traffic control instruction over the communication network to a second mobile traffic participant.

18. The method according to claim 17, wherein the at least one traffic control instruction relates to providing routing information to the second mobile traffic participant.

19. The method according to claim 17, further comprising transmitting a traffic control instruction over the communication network to at least one traffic signal.

20. The method according to claim 19, further comprising providing routing information to the at least one mobile traffic participant upon receipt of travel data by a traffic control system in the roadway travel data exchange network.
